(19) United States
(12) Patent Application Publication
(10) Pub. No.: US 2026/0327011 A1
(43) Pub. Date: Oct. 22, 2026

(54) AUTOMATIC SCRAP DISCHARGE SYSTEM

(71) Applicant: Jae Hyeong HAN, Sangju-si (KR)

(72) Inventor: Jae Hyeong HAN, Sangju-si (KR)

(21) Appl. No.: 19/491,130

(22) PCT Filed: Nov. 28, 2023
(86) PCT No.: PCT/KR2023/019293

§ 371 Date: Dec. 8, 2025

(30) Foreign Application Priority Data
Nov. 16, 2023 (KR) 10-2023-0159158

(51) Int. Cl. B65G 11/12; B21D 45/02; B65G 41/00

(52) U.S. Cl. CPC B65G 11/126; B21D 45/02; B65G 41/002; B65G 41/007

(57) ABSTRACT

The present invention relates to an automatic scrap discharge system configured to more effectively discharge mold scrap discharged from a press device without a discharge load by using a plurality of discharge chutes which undergo overall wave-like motion (wave-like motion or undulating motion) while being raised and lowered by an elevating means, the automatic scrap discharge system comprising: a plurality of discharge chutes (2) each having a bottom part (8); vertical parts (9, 10) bent upward at a predetermined height on the front and rear surfaces of the bottom part (8); reinforcing members (17, 18) fixed to the outer surfaces of the vertical parts (9, 10) and having outward shaft pins (13, 14) formed thereon; an upper end part of a U-shaped support member (12) axially installed on the outward shaft pins (13, 14) by means of bearings (19, 20); and a rod (16) of an elevating cylinder (15) vertically installed at the central lower part of the support member (12). The bottom part (8) may have any one of a semi-circular shape, a semi-elliptical shape, a semi-parabolic shape, and a semi-elliptical parabolic shape, and the plurality of discharge chutes (2) have a stepped part (11) formed by overlapping and connecting two to eight piece chutes having the bottom part (8) and the opposing vertical parts (9, 10), and may have a slope inclined such that the frontmost discharge chute (2) is positioned higher, and the rearmost discharge chute in which a discharge port (3) is located is positioned lower.

### TECHNICAL FIELD

The present invention relates to an automatic scrap discharge system configured to more effectively discharge mold scrap discharged from a press machine without any discharge load by using a plurality of discharge chutes configured to perform overall wave motion (wave-like motion or undulating motion) through upward-and-downward movement thereof by an upward-and-downward movement means.

### BACKGROUND ART

In general, a lower mold is installed on a bed of a press machine, and an upper mold is installed directly on an upper portion of the lower mold. When a press material (for example, a metal plate) is fed (introduced) into the lower mold, the upper mold is moved downwards by an upward-and-downward movement means to press the press material. Then, molding (plastic deformation) is performed by bending, drawing, or shearing the press material. In this molding process, scrap is generated.

The scrap needs to be discharged quickly and continuously out of the mold to prevent interference with a press molding process. To this end, a scrap discharge device (or a scrap discharge means) is installed around the periphery of the press machine to discharge the scrap generated during the molding process.

The scrap discharge device moves and drops the scrap into a collection container for disposal or discharges the scrap along a ramp having a predetermined slope.

Meanwhile, the ramp is installed in a narrow space between the press machines or is installed behind the press machine. In this case, since an installation space for the ramp is narrow, it is difficult to secure the necessary slope of the ramp for scrap discharge. Accordingly, the ramp may not be appropriately installed due to space or structural limitations. In consideration of the above-described problems, a vibration device is employed to vibrate a ramp, thereby forcing scrap to be discharged along the slope of the ramp. Alternatively, a reciprocating device is employed to forcibly discharge scrap, or a vibration device and a reciprocating device are installed in parallel around the periphery of a press machine to discharge scrap. However, the above-described systems generally have low efficiency in discharging scrap and generate significant scrap discharge load, leading to deterioration in productivity. Furthermore, workers assisting with scrap discharge may be exposed to safety hazards.

### DISCLOSURE

### Technical Problem

Therefore, the present invention has been made in view of the above problems, and it is an object of the present invention to provide an automatic scrap discharge system configured to more effectively discharge mold scrap discharged from a press machine without any discharge load by using a plurality of discharge chutes configured to perform wave motion (wave-like motion or undulating motion) through upward-and-downward movement thereof by an upward-and-downward movement means.

### Technical Solution

In accordance with the present invention, the above and other objects can be accomplished by the provision of an automatic scrap discharge system including a plurality of discharge chutes each having a bottom portion, vertical portions respectively disposed on a front surface and a rear surface of the bottom portion, each of the vertical portions being bent upwards at a predetermined height, reinforcing members fixed to outer surfaces of the respective vertical portions, each of the reinforcing members having an outward shaft pin formed thereon, an upper end portion of a support member having a “U” shape, the upper end portion being axially installed on the outward shaft pin using a bearing, and a rod of an upward-and-downward movement cylinder, the rod being vertically installed at a central lower portion of the support member, wherein the discharge chutes are connected in a row in a state in which end portions of the adjacent discharge chutes overlap each other to provide mutual support between the end portions, and wherein the discharge chutes are configured to be moved upwards and downwards by the respective upward-and-downward movement cylinders, thereby performing overall wave motion.

The bottom portion may have any one of a semi-circular shape, a semi-elliptical shape, a semi-parabolic shape, and a semi-elliptical parabolic shape.

A plurality of ball plungers may be installed with a predetermined interval therebetween at the end portions of the discharge chutes such that the end portions of the adjacent discharge chutes are placed on the ball plungers and are supported by the ball plungers in a point-contact manner.

Each of the ball plungers may include a main body having a threaded portion of a predetermined pitch, the threaded portion being formed on an outer circumferential surface of the main body, and an upwardly open spring chamber formed in the main body, a spring may be inserted into and installed in the spring chamber, and a ball bearing elastically supported upwards by the spring may partially protrude outside the main body to perform rolling motion on an upper portion of the spring.

The discharge chutes may have step portions formed by overlapping and connecting two to eight piece chutes each having the bottom portion and the opposite vertical portions.

The discharge chutes may be arranged to form an inclination in such a manner that the foremost discharge chute is positioned higher than the rearmost discharge chute.

The inclination may range from 10° to 40°.

The outward shaft pin may be positioned closer to one side of the discharge chutes to allow the discharge chutes to be inclined.

The automatic scrap discharge system may further include upward protrusions bent outwards at an angle of 10° to 45° from upper portions of the respective vertical portions.

The automatic scrap discharge system may further include an end plate fixed to a front end of the foremost discharge chute.

The discharge chutes may be installed in a linear shape or may be installed in a curved shape to avoid an obstacle.

The automatic scrap discharge system may further include a scrap discharge hopper installed at the discharge port, the scrap discharge hopper being configured to receive scrap discharged by the discharge chutes and discharge the scrap outside a space in which a press machine is installed.

### Advantageous Effects

An automatic scrap discharge system 1 of the present invention quickly and effectively discharges, to a discharge port 3, scrap S dropped and introduced (fed) into discharge chutes 2 through a ramp of a scrap discharge device without any discharge load along the discharge chutes 2 configured to perform wave motion by respective upward-and-downward movement cylinders 15, thereby having an effect of achieving smooth press operation.

The cross-sectional shape of a bottom portion 8 of the discharge chute 2 of the present invention is a semi-circular shape, a semi-elliptical shape, a semi-parabolic shape, or a semi-elliptical parabolic shape. Accordingly, even if oil such as drawing oil is applied to the front surface or the front and back surfaces of the scrap S, it is possible to prevent contact or adhesion between the scrap S and the bottom portion 8. Accordingly, movement and discharge of the scrap S is not affected by oil.

Since a plurality of ball plungers 30 is installed on portions where the end portions of the discharge chutes 2 are placed such that the discharge chutes 2 adjacent to each other are in point contact with each other, it is possible to prevent surface contact or friction between the discharge chutes 2 adjacent to each other, thereby having an effect of preventing shortening of the lifespan of the discharge chutes 2 and noise generation therebetween and achieving smooth wave motion.

The automatic scrap discharge system 1 of the present invention may smoothly discharge, regardless of the size of the scrap, all scrap generated during press molding, thereby having an effect of improving productivity.

The present invention is a highly useful invention that has an effect of protecting the safety of workers in relation to discharge of the scrap generated during press operation.

### DESCRIPTION OF DRAWINGS

The above and other objects, features and other advantages of the present invention will be more clearly understood from the following detailed description taken in conjunction with the accompanying drawings, in which:

FIG. 1 is a perspective view showing an embodiment of the present invention;

FIG. 2 is a plan view showing the embodiment of the present invention;

FIG. 3 is a front view showing the embodiment of the present invention;

FIG. 4 is a plan view showing a use state according to the embodiment of the present invention;

FIG. 5 is a front view showing another embodiment of the present invention;

FIG. 6 is a perspective view of a main part according to the embodiment of the present invention;

FIG. 7 is a perspective view of a tip portion according to the embodiment of the present invention;

FIG. 8 is a cross-sectional view of the main part according to the embodiment of the present invention;

FIG. 9 is a cross-sectional view showing a biased state of a shaft pin according to the embodiment of the present invention;

FIG. 10 is a partial cross-sectional view of a ball plunger according to the embodiment of the present invention;

FIG. 11 is a partial cross-sectional view of a shaft pin of a discharge chute according to the embodiment of the present invention;

FIG. 12 is a cross-sectional view showing a state in which the discharge chute according to the embodiment of the present invention is partially moved upwards;

FIG. 13 is a cross-sectional view showing a state in which the discharge chute according to the embodiment of the present invention is maximally moved upwards;

FIG. 14 is a cross-sectional view showing a state in which a plurality of discharge chutes according to the embodiment of the present invention is interconnected and supported by one another;

FIG. 15 is a cross-sectional view showing a state in which a plurality of discharge chutes according to the embodiment of the present invention is interconnected and inclined;

FIG. 16 is a plan view of an automatic scrap discharge system according to another embodiment of the present invention, configured to be installed to avoid an obstacle;

FIG. 17 is a perspective view of the automatic scrap discharge system according to another embodiment of the present invention, configured to be installed to avoid an obstacle;

FIG. 18 is a cross-sectional view showing a scrap discharge state according to the embodiment of the present invention, in which scrap is introduced into a first discharge chute;

FIG. 19 is a cross-sectional view showing a scrap discharge state according to the embodiment of the present invention, in which scrap is moved to a third discharge chute;

FIG. 20 is a cross-sectional view showing a scrap discharge state according to the embodiment of the present invention, in which scrap is moved upwards by upward movement of the third discharge chute;

FIG. 21 is a cross-sectional view showing a scrap discharge state according to the embodiment of the present invention, in which scrap is moved to a fifth discharge chute;

FIG. 22 is a cross-sectional view showing a scrap discharge state according to the embodiment of the present invention, in which scrap is moved upwards by upward movement of the fifth discharge chute;

FIG. 23 is a cross-sectional view showing a scrap discharge state according to the embodiment of the present invention, in which scrap is moved to a seventh discharge chute;

FIG. 24 is a cross-sectional view showing a scrap discharge state according to the embodiment of the present invention, in which scrap is moved upwards by upward movement of the seventh discharge chute;

FIG. 25 is a cross-sectional view showing a scrap discharge state according to the embodiment of the present invention, in which scrap is discharged through a discharge port of an eighth discharge chute; and

FIG. 26 is a side cross-sectional view of a scrap discharge hopper according to the embodiment of the present invention.

### DESCRIPTION OF REFERENCE NUMERALS

1: Automatic scrap discharge system
2, 2, 21, 22, 23, 24, 25, 26, 27, 28: Discharge chute
2a, 2b, 2c, 2d: Piece chute
3: Discharge port (outlet)
4: Press machine
5: Material conveyance device
5a: Material supply device
5b: Material discharge device
6: Lower mold
7: Ramp
8: Bottom portion
9, 10: Vertical portion
9a, 10a: Upward protrusion
11: Step portion
12: Support member
13, 14: Shaft pin
15, 151, 152, 153, 154, 155, 156, 157, 158: Upward-and-downward movement cylinder
16, 16a: Upward-and-downward movement cylinder rod
17, 18: Reinforcing member
19, 20: Bearing
21a: End plate
29: Frame
30: Ball plunger
31: Threaded portion
32: Main body
33: Spring seal
34: Spring
35: Ball bearing
36: Screw hole
37: Reinforcing plate
50: Obstacle
150: Support
154a to 158a: Two-stage upward-and-downward movement cylinder
θ, θ2: Inclination (angle)
S: Scrap

### BEST MODEL

Hereinafter, preferred embodiments of the present invention will be described in detail with reference to the accompanying drawings. In describing the embodiments of the present invention, identical components in the drawings are, if
possible, denoted by the same reference numerals, and when it is determined that a detailed description of related publicly known techniques may obscure the gist of the embodiments disclosed in this specification, the detailed description thereof will be omitted. In addition, the components are schematically shown in the accompanying drawings for ease of description of the embodiments of the present disclosure and may be different from the forms actually implemented.

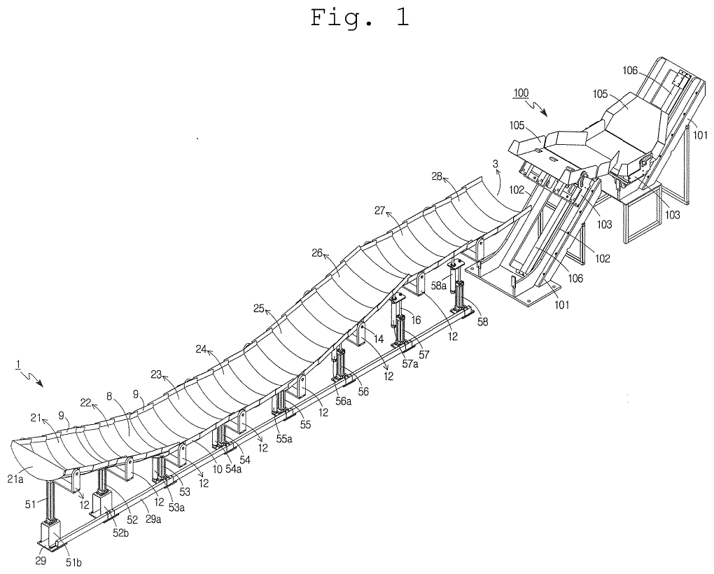

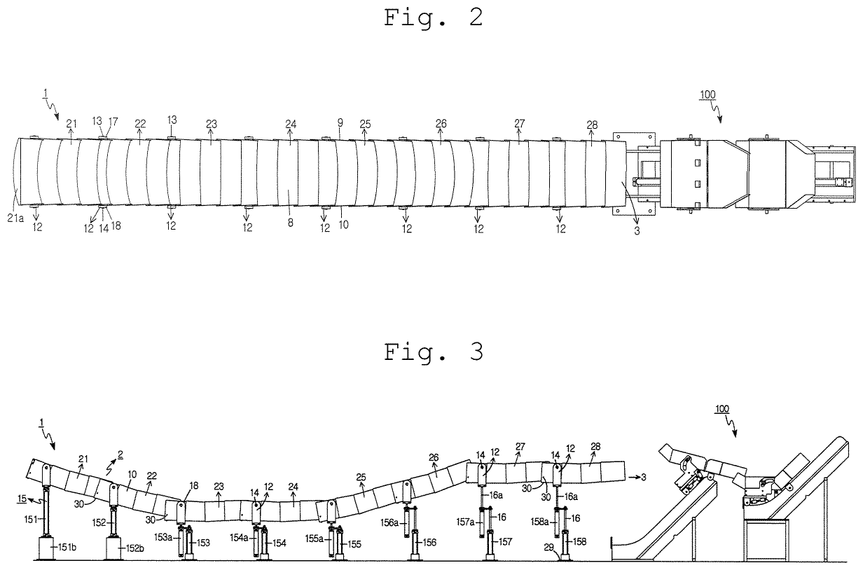

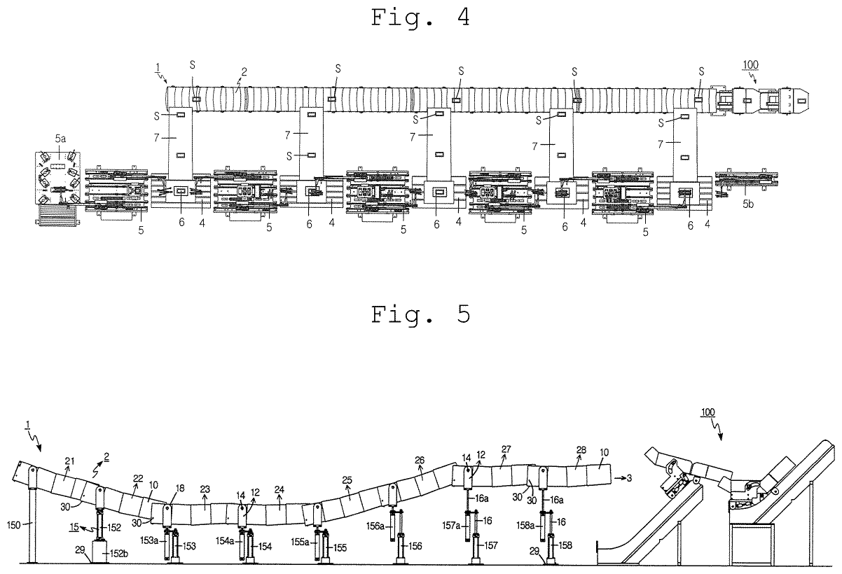

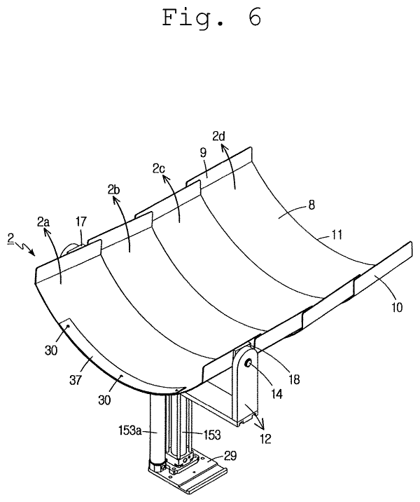

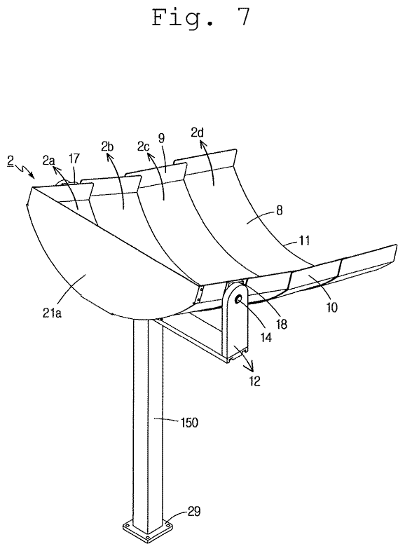

FIG. 1 is a perspective view of an automatic scrap discharge system 1 according to an embodiment of the present invention, and FIG. 2 is a front view of the automatic scrap discharge system 1. In the automatic scrap discharge system 1, a plurality of discharge chutes 2 having a predetermined size is installed to be interconnected in a row, and all of the discharge chutes 2 are configured to perform wave motion (wave-like motion or undulating motion) through upward-and-downward movement thereof by respective upward-and-downward movement means (respective upward-and-downward movement cylinders). In this manner, when pieces of scrap S discharged from a scrap discharge device 6 of a press machine 4 are fed into the discharge chutes 2, the pieces of scrap S are moved quickly to a discharge port 3 without any discharge load by wave motion and are discharged effectively.

The automatic scrap discharge system 1 is installed at the lower end of a ramp 7 of the scrap discharge device 6 installed at one side of a lower mold 5 of the press machine 4 or installed at the rear end (or one side) of the lower mold 5, as shown in FIG. 4. Here, a plurality of press machines 4 may be installed with a predetermined interval therebetween. The automatic scrap discharge system 1 receives the scrap S that is slidably discharged or is dropped into and discharged through the ramp 7, and quickly and effectively moves and discharges the scrap S.
The discharge end of the ramp 7 of the scrap discharge device is positioned or configured to be located above the discharge chute 2. Accordingly, the scrap S is dropped onto the ramp 7 and then is discharged through the ramp 7. Thereafter, the scrap S is introduced (or is fed) into the discharge chute 2. In FIG. 4, reference numeral 5a represents a material supply device, reference numeral 5 represents a material conveyance device, and reference numeral 5b represents a material discharge device.

The present invention further includes a scrap discharge hopper 100 that is installed at the discharge port 3 of the automatic scrap discharge system 1, receives the scrap S discharged via the discharge chute 2, and discharges the scrap S to the outside of a space in which the press machine 4 is installed.

The discharge chute 2 of the present invention has a predetermined width and length so as to allow the scrap S which freely falls through the ramp 7 of the scrap discharge device 6 to be introduced (fed) into the discharge chute and seated therein. Furthermore, the discharge chute 2 has a bottom portion 8 having an upwardly open semi-circular, semi-elliptical, semi-parabolic, or semi-elliptical parabolic shape.

The bottom portion 8 has vertical portions 9 and 10 each having a predetermined height, located on the front and rear surfaces thereof and formed to be bent upwards, thereby enabling the scrap S falling through the ramp 7 to be effectively introduced into the bottom portion 8 of the discharge chute 2. Even if the front surface or the front and back surfaces of the scrap S are contaminated with oil such as drawing oil, since the cross-sectional shape of the bottom portion 8 is a semi-circular, semi-elliptical, semi-parabolic, or semi-elliptical parabolic shape, it is possible to prevent contact or adhesion between the scrap S and the bottom portion 8. Accordingly, movement and discharge of the scrap S is not affected by oil.

In the present invention, the upper surface of the bottom portion 8 through which the scrap S passes is preferably configured to significantly reduce resistance against the scrap S, thereby preventing friction and wear of the bottom portion. For example, oil may be applied to the upper surface, or the upper surface may be made slick or mirror-polished to reduce the coefficient of friction.

The discharge chute 2 is formed of a plurality of piece chutes 2a, 2b, 2c, and 2d each having the bottom portion 8 and the opposite vertical portions 9 and 10.
Here, the piece chutes are connected to each other in an overlapping arrangement, thereby forming an integrated configuration.

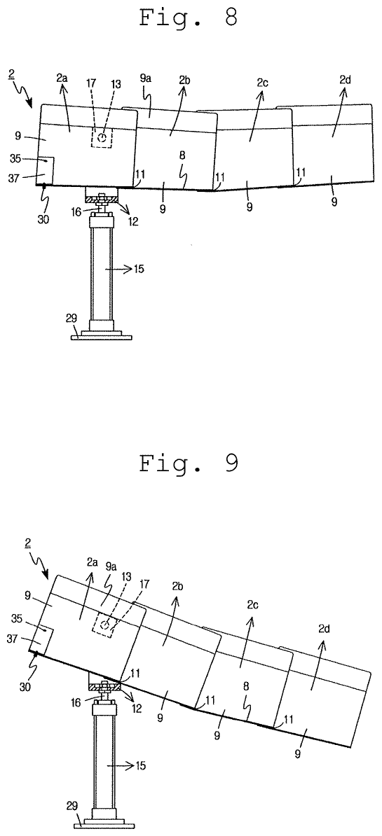

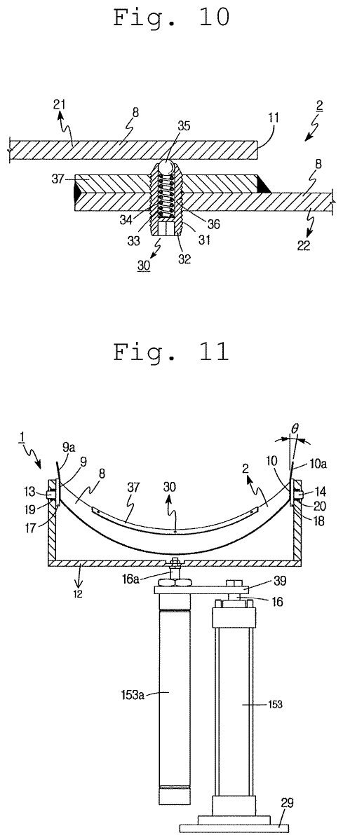

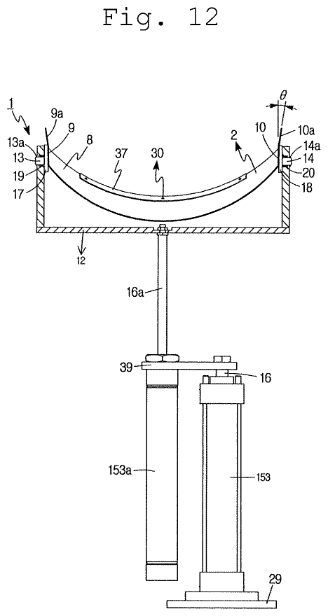

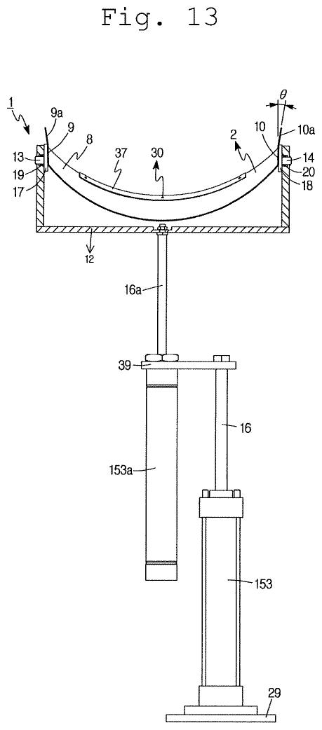

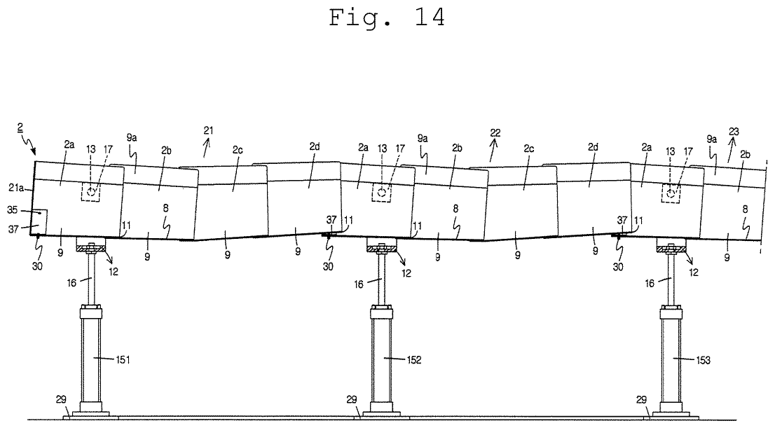

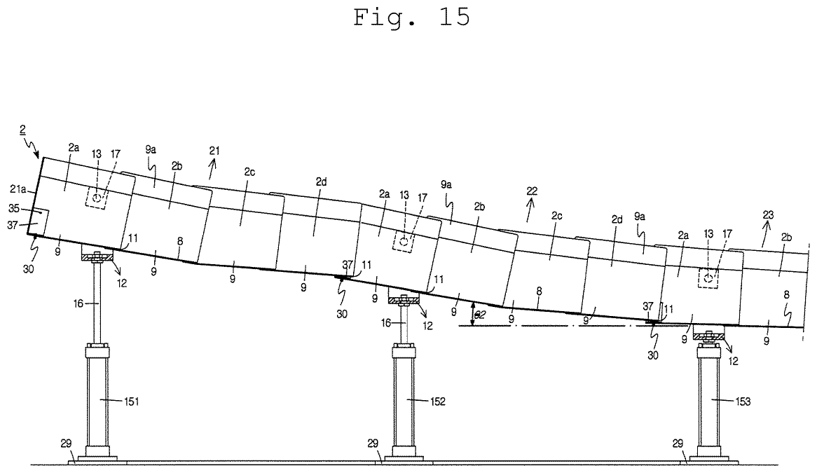

For example, two to eight piece chutes may be provided to form the discharge chute. Here, four piece chutes 2a, 2b, 2c, and 2d are fixed by a method such as vertically overlapping and fastening left and right edge portions of the piece chutes or welding the same. Step portions each having a height difference equal to a thickness of each of the chutes 2a, 2b, 2c, and 2d are formed on the upper and lower surfaces of the discharge chute 2, respectively, at a portion where the left and right edge portions vertically overlap each other. Further, the step portion 11 formed on the upper surface of the discharge chute 2 is configured to be lowered toward the discharge port 3 through which the scrap S is discharged, as shown in FIGS. 8 to 10 and 14. In this manner, the scrap S discharged along the discharge chute 2 is prevented from moving in the opposite direction (reverse direction) of the discharge port 3 by being caught by the step portion 11. Therefore, the scrap S is discharged quickly and effectively toward the discharge port 3.

A forward-and-rearward width of each of the piece chutes 2a, 2b, 2c, and 2d is formed to extend such that the overall plane of each of the piece chutes is a square or a rectangle close to a square, thereby enabling the scrap S falling through the ramp 7 to be effectively introduced into and placed on the discharge chute 2 and discharged therefrom.

Preferably, the discharge chute 2 and the piece chutes 2a, 2b, 2c, and 2d have sufficient strength and thickness to support and move the scrap S.

Reinforcing members 17 and 18 having outward shaft pins 13 and 14 respectively formed thereon are installed on the outer surfaces of vertical portions 9 and 10, and the upper ends of a fork-shaped or U-shaped support member 12 are axially installed on the outward shaft pins 13 and 14 using bearings 19 and 20, thereby enabling the discharge chute 2 to be rotated around the outward shaft pins 13 and 14.

An upper portion of a rod 16 of a vertically installed upward-and-downward movement cylinder 15 is fixed to a central lower portion of the support member 12. When the rod 16 is moved upwards or downwards by the upward-and-downward movement cylinder 15, the discharge chute 2 may be moved upwards or downwards.

To satisfy upward-and-downward movement stroke, an upward-and-downward movement cylinder having a long upward-and-downward movement stroke may be installed at the discharge chute 2 such that sufficient upward-and-downward movement is enabled in the discharge chute 2 at a relatively high location. Alternatively, a two-stage cylinder, a dual-cylinder, or a two-way cylinder may be used or installed at the discharge chute 2. Here, the cylinder installed near the discharge port 3 may be a single-acting cylinder or a single-stage cylinder.

For convenience of description, the present invention exemplifies a configuration in which eight discharge chutes 2 including first to eighth discharge chutes 21, 22, 23, 24, 25, 26, 27, and 28 are moved upwards and downwards (perform wave motion) by respective upward-and-downward movement cylinders 151, 152, 153, 154, 155, 156, 157, and 158 to discharge the scrap S.

The rear end of the first discharge chute 21 is supported by overlapping the front end of the second discharge chute 22 by a predetermined width, the rear end of the second discharge chute 22 is supported by overlapping the front end of the third discharge chute 23 by a predetermined width, the rear end of the third discharge chute 23 is supported by overlapping the front end of the fourth discharge chute 24 by a predetermined width, the rear end of the fourth discharge chute 24 is supported by overlapping the front end of the fifth discharge chute 25 by a predetermined width, the rear end of the fifth discharge chute 25 is supported by overlapping the front end of the sixth discharge chute 26 by a predetermined width, the rear end of the sixth discharge chute 26 is supported by overlapping the front end of the seventh discharge chute 27 by a predetermined width, and the rear end of the seventh discharge chute 27 is supported by overlapping the front end of the eighth discharge chute 28 by a predetermined width. As a result, all of the discharge chutes are connected in a row. A plurality of ball plungers 30 is installed with a predetermined interval therebetween along a portion where the discharge chutes 2 partially overlap each other to be supported by each other, thereby significantly reducing friction and noise generated between the discharge chutes 2 adjacent to each other.

The number of first to eighth discharge chutes 21, 22, 23, 24, 25, 26, 27, and 28 may be increased or decreased depending on an overall discharge section through which the scrap S is discharged or an overall discharge length. Of course, the length, width, and size of the discharge chute 2 may be appropriately adjusted.
It is preferable to form upward protrusions 9a and 10a on the upper portions of the vertical portion 9 and 10. Here, each of the upward protrusions 9a and 10 a is bent outwards at a predetermined angle θ to allow the scrap S to be more reliably introduced into the discharge chute 2. The predetermined angle θ may range from 10° to 45°.

The automatic scrap discharge system 1 of the present invention is formed to have an inclined shape such that a front end where the first discharge chute 21 is provided is positioned higher than the eighth discharge chute 28 where the discharge port 3 is provided, thereby effectively discharging the scrap S. Therefore, the entirety of the discharge chutes 2 moves with wave motion in an inclined position to discharge the scrap S.

An inclination angle θ of the automatic scrap discharge system 1 may range from 10° to 40°. If the overall length of the automatic discharge system 1 becomes shorter, the inclination may become steeper. Conversely, if the overall length of the automatic scrap discharge system 1 becomes longer, the inclination angle may become gentler.

In the present invention, the discharge chute 21 located at the front end of the automatic scrap discharge system 1 does not require upward-and-downward movement, and the height thereof is fixed. In this case, as shown in FIG. 5, the support member 12 may be installed on the upper portion of the vertical support 150 instead of the upward-and-downward movement cylinder 151 to support the foremost discharge chute 21.

The front end of the foremost discharge chute 21 is preferably finished with a finishing plate or an end plate 21a, thereby preventing the scrap S introduced into the foremost discharge chute 21 from moving to or deviating from the front end of the foremost discharge chute 21.

A fixing plate 29 located at the bottom portion of the upward-and-downward movement cylinder 15 may be fixed to the floor or ground where the press machine 4 is installed using anchor bolts or may be fixed to a foundation stone or a separate support frame. A plurality of upward-and-downward movement cylinders 15 may be stably installed by using a long frame 29a connecting the fixing plates 29 to each other.

A position of each of the shaft pins 13 and 14 installed in the discharge chute 2 or a point at which each of the shaft pins 13 and 14 is supported is configured or set to be located on one side of the discharge chute 2, such as the first piece chute 2a, or located on the opposite side of the discharge port 3. In this configuration, the center of gravity of the discharge chute 2 is biased in the opposite direction of the discharge port 3, thereby allowing the discharge chute 2 to be more easily inclined in a direction toward the discharge port 3.

Accordingly, the end of the discharge chute 2, which is oriented toward the discharge port 3, is supported by being placed on the upper portion of another adjacent discharge chute 2 and is configured to be moved upwards and downwards, thereby enabling the discharge chutes 2 connected in a row to perform wave motion.

In the present invention, the ball plungers 30 are installed with a predetermined interval therebetween at a portion on which the end of discharge chute 2 is placed to prevent surface contact or friction between the discharge chutes 2 adjacent to each other. Accordingly, it is possible not only to significantly reduce shortening of the lifespan of the discharge chute 2 and noise generation, but also to perform smooth wave motion.

As shown in FIG. 10, the ball plunger 30 includes a main body 32 having a threaded portion 31 of a predetermined pitch formed on the outer circumferential surface thereof, and an upwardly open spring chamber 33 formed in the main body. A spring 34 is inserted into and installed in the spring chamber 33, and a spherical ball bearing 35 elastically supported upwards by the spring 34 is installed on the upper portion of the spring 34 to perform rolling motion without being detached (separated) from the main body 32.

The ball plunger 30 is coupled to a screw hole 36 formed in one side of the bottom portion 8 using the threaded portion 31 formed on the outer circumferential surface of the main body 32. Therefore, the ball bearing 35 partially protruding upwards from the main body 24 supports the bottom surface of the bottom portion 8 of the discharge chute 2 and performs rolling motion in a point-contact manner. Accordingly, contact or friction between the discharge chutes 2 adjacent to each other is prevented, and noise is not generated, resulting in smooth wave motion of the entirety of the discharge chutes 2.

Since load (or vertical stress) from the discharge chutes 2 adjacent to each other concentrates on the ball bearing 35, the ball bearing 35 is preferably formed of a wear-resistant material such as stainless steel or alloy steel to suppress oxidation and wear of the ball bearing and to prevent shortening of the lifespan thereof.

As shown in FIG. 10, the ball plunger 30 is preferably configured to include a reinforcing plate 37 fixed to the upper surface or the lower surface of the bottom portion 8 of the discharge chute 2, which supports the neighboring discharge chute 2, so that a predetermined thickness may be maintained for reliable coupling of the ball plunger 30.

In the present invention, as described above, the ball plunger 30 is installed at the front end of the discharge chute 2, and the ball bearing 35 protrudes upwards to support the neighboring discharge chute 2. However, the ball plunger 30 may also be installed at the rear end of the discharge chute 2, and the ball bearing 35 may protrude downwards to support the front end of the neighboring discharge chute 2. In this case as well, movement or discharge of the scrap S should not be affected or hindered.

In the present invention, the first to eighth upward-and-downward movement cylinders 151, 152, 153, 154, 155, 156, 157, and 158 may be configured as a two-stage cylinder to satisfy upward-and-downward movement stroke. For example, one side of a connecting member 39 is fixed to the rod end of a third upward-and-downward movement cylinder 153, and a two-stage upward-and-downward movement cylinder 153a is installed on the upper surface of the other side of the connecting member 39. Then, the support member 12 is fixedly installed at the rod end of the two-stage upward-and-downward movement cylinder 153a, thereby enabling the third discharge chute 23 to be moved upwards and downwards.

Similarly, one end of each of the connecting members 39 is fixed to a corresponding one of the rod ends of the fourth to eighth upward-and-downward movement cylinders 154 to 158, and two-stage upward-and-downward movement cylinders 154a to 158a are installed on the respective upper surfaces of the other ends of the connecting members 39. Then, the support members 12 are fixedly installed at the respective rod ends of the two-stage upward-and-downward movement cylinders 154a to 158a, thereby enabling the fourth to eighth discharge chutes 24 to 28 to be moved upwards and downwards. Accordingly, the discharge chute 2 is moved upwards and downwards by the vertically installed upward-and-downward movement cylinder 15, and wave motion (sine wave motion) is performed throughout all of the discharge chutes. As a result, the scrap S introduced into the bottom portion 8 is quickly and effectively discharged through the discharge port 3 located at a lower position without any discharge load, and smooth press operation is implemented.

The upward-and-downward movement cylinders 15, 151 to 158, and 153a to 158a are described as examples of the upward-and-downward movement means for upward-and-downward movement of the discharge chutes 2, 21, 22, 23, 24, 25, 26, 27, and 28. The upward-and-downward movement means may, of course, be configured using a combination of a reversible geared motor and a ball screw. Furthermore, it should be understood that other types of upward-and-downward movement means may be used to perform individual upward-and-downward movement of the discharge chute 2.

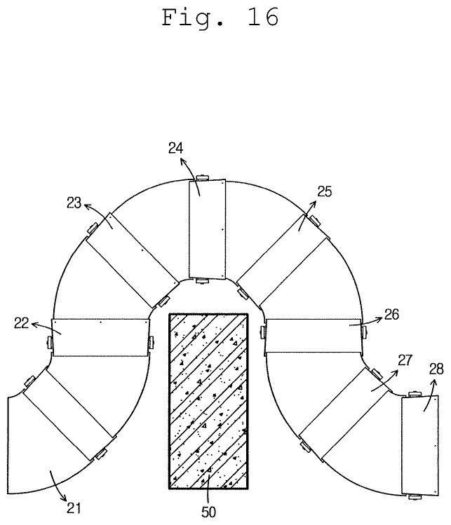

FIGS. 16 and 17 are a plan view and a perspective view of another embodiment of the present invention. In the present embodiment, if an obstacle 50 such as a column or a structure is present in a section where the automatic scrap discharge system 1 is installed, the automatic scrap discharge system 1 may be installed while avoiding the obstacles 50. That is, in consideration of the shape, the size, and other factors of the obstacle 50, a plurality of discharge chutes 21, 22, 23, 24, 25, 26, 27, and 28 is formed in a curved shape without contacting the obstacle 50. In this manner, the scrap S may be moved (conveyed) and discharged to the discharge port 3 through the discharge chutes 21, 22, 23, 24, 25, 26, 27, and 28 connected to each other in a curved shape.

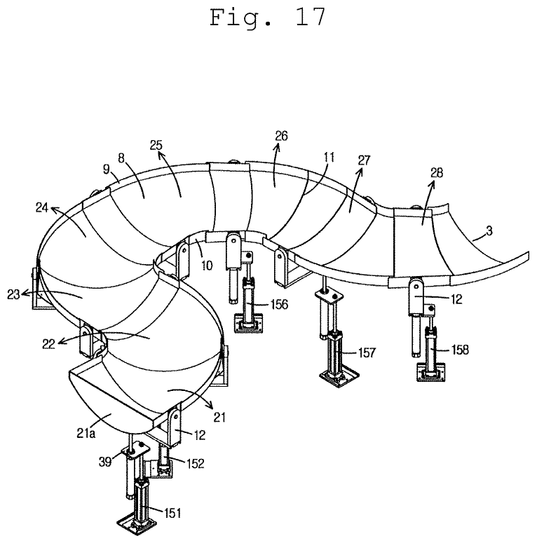

FIGS. 18 to 25 each show a process of discharging the scrap S dropped and introduced into the first discharge chute 21 through the ramp 7 by wave motion of the automatic scrap discharge system 1 of the present invention.

Under the control of a controller, the automatic scrap discharge system 1 of the present invention performs wave motion using a plurality of discharge chutes 2 configured to move upwards and downwards by the upward-and-downward movement cylinder 15.

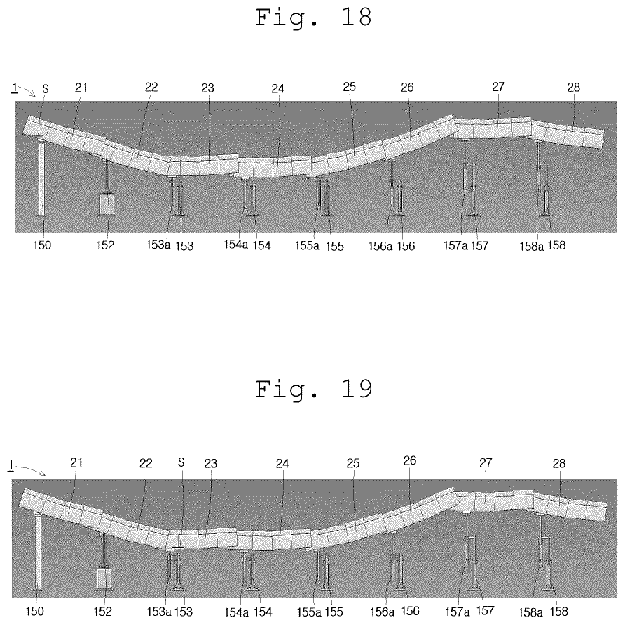

In this state, as shown in FIG. 18, the scrap S dropped onto and discharged through the ramp 7 is placed on the bottom portion 8 of the first discharge chute 21. Then, as shown in FIG. 19, the second discharge chute 22 and the third discharge chute 23 are inclined in a direction toward the discharge port 3 by wave motion resulting from downward movement of the second upward-and-downward movement cylinder 152, the third upward-and-downward movement cylinder 153, and the second-stage upward-and-downward movement cylinder 153a. Thereafter, the scrap S that has been introduced into the first discharge chute 21 is slidably moved to the bottom portion 8 of the third discharge chute 23 located lower than the second discharge chute 22 via the bottom portion 8 of the second discharge chute 22.

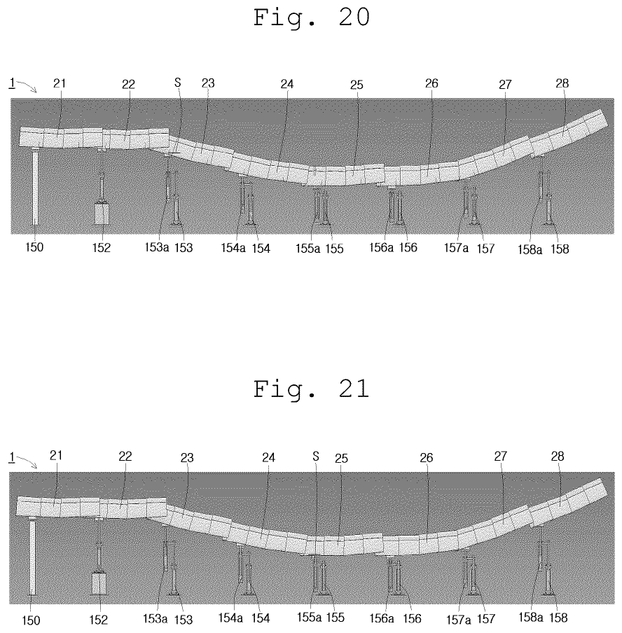

Further, as shown in FIG. 20, the third upward-and-downward movement cylinder 153 and the second-stage upward-and-downward movement cylinder 153a are maximally moved upwards, and the fourth upward-and-downward movement cylinder 154 and the second-stage upward-and-downward movement cylinder 154a are partially moved upwards. Accordingly, the third discharge chute 23 is maximally moved upwards, and the fourth discharge chute 24 is partially moved upwards. As a result, as shown in FIG. 21, the scrap S is slidably moved to the bottom portion 8 of the fourth discharge chute 24 via the bottom portion 8 of the third discharge chute 23 located lower than the second discharge chute 22.

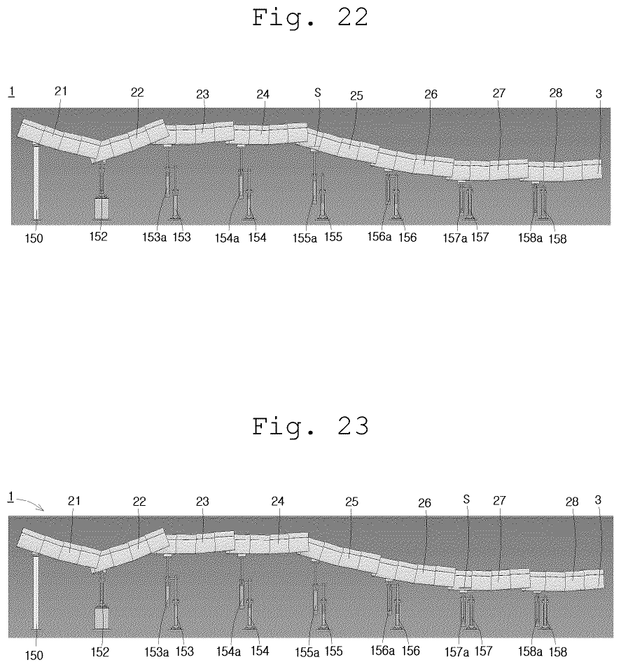

Further, as shown in FIG. 22, the fifth upward-and-downward movement cylinder 155 and the second-stage upward-and-downward movement cylinder 155a are maximally moved upwards, and the sixth upward-and-downward movement cylinder 156 and the second-stage upward-and-downward movement cylinder 156a are partially moved upwards, thereby causing the fifth discharge chute 25 to be maximally moved upwards. Then, as shown in FIG. 23, while the sixth discharge chute 26 is partially moved upwards, the scrap S is slidably moved to the bottom portion 8 of the seventh discharge chute 27 via the bottom portion 8 of the sixth discharge chute 26 located lower than the fifth discharge chute 25.

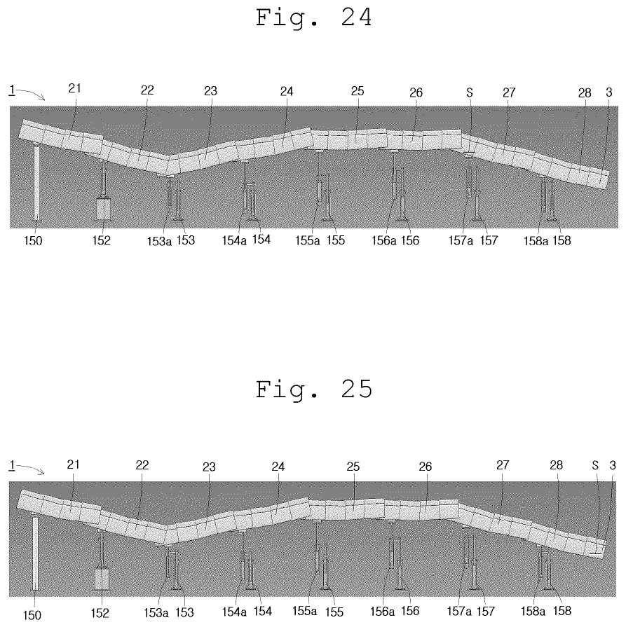

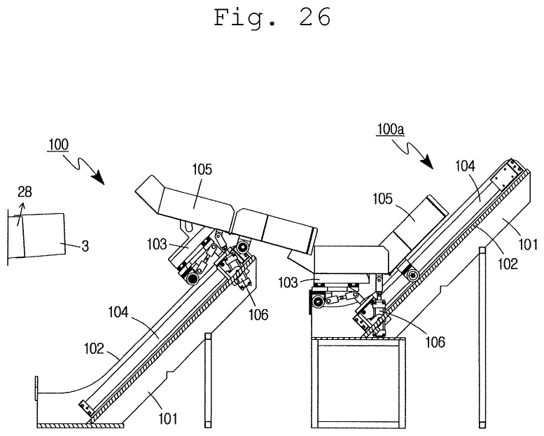

Additionally, as shown in FIG. 24, the seventh upward-and-downward movement cylinder 157 and the second-stage upward-and-downward movement cylinder 157a are maximally moved upwards, and the eighth upward-and-downward movement cylinder 158 and the second-stage upward-and-downward movement cylinder 158a are partially moved upwards, thereby causing the seventh discharge chute 27 to be maximally moved upwards. Then, as shown in FIG. 25, while the eighth discharge chute 28 is partially moved upwards, the scrap S is discharged to the discharge port 3 via the bottom portion 8 of the eighth discharge chute 28 located lower than the seventh discharge chute 27.

As shown in FIGS. 18 to 25, the automatic scrap discharge system 1 of the present invention is configured such that wave motion of a plurality of discharge chutes 2 connected in a row is performed by upward-and-downward movement of the respective upward-and-downward movement cylinders at a predetermined cycle.

For convenience of description, in the present invention, as shown in FIGS. 18 to 25, after the scrap S is introduced into the first discharge chute 21, the scrap S sequentially passes through the second discharge chute 22 to the eighth discharge chute 28 and then is discharged to the discharge port 3. Since the ramp 7 of at least one of the plurality of scrap discharge devices is installed at a predetermined location on the automatic scrap discharge system 1 of the present invention, the scrap S is dropped and introduced into the discharge chute 2 at the corresponding location and is rapidly moved along a plurality of discharge chutes 2 configured to perform wave motion. Thereafter, the scrap S is discharged to the discharge port 3.

That is, since a location where the scrap S is dropped is a location where the ramp 7 of at least one of the plurality of scrap discharge devices is installed, at least one piece of scrap S is dropped or fed into at least one location of the automatic scrap discharge system 1, either simultaneously or with a time lag, and then is discharged to the discharge port 3.

The scrap S discharged through the discharge port 3 is discharged to the outside by the scrap hopper 100, thereby performing a smooth press molding operation without any discharge load.

In another embodiment of the present invention, as shown in FIGS. 16 and 17, the scrap S is discharged as described above, and a different point as compared with the previous embodiment is that the scrap S is moved along a curved path formed by the plurality of discharge chutes 21, 22, 23, 24, 25, 26, 27, and 28 configured to avoid the obstacle 50, the upward-and-downward movement cylinders, and the two-stage cylinders.

In the present invention, the discharge port 3 is installed to be inclined in the downward direction, and the scrap S generated during the press molding process is rapidly discharged to the discharge port 3 by the discharge chutes 2 configured to perform wave motion by the respective elevating cylinders 15, thereby preventing the discharge load of the scrap S and achieving a smooth press molding operation.

The scrap discharge hopper 100 installed at the discharge port 3 of the automatic scrap discharge system 1 receives the discharged scrap S in a bucket, moves the scrap S upwards, and discharges the scrap S outside a space in which the press machine 4 is installed.

As shown in FIG. 26, the scrap discharge hopper 100 includes a pair of inclined rails 102 installed on the front surface of an inclined main body 101 having a low front end and a high rear end. A conveyance machine 103 is installed on the inclined rails 102 to enable reciprocating movement. A cylinder 104 is installed on one side of the main body 101, the conveyance machine 103 is axially installed on the rod end of the cylinder 104, and a scrap S collection bin 105 is axially installed at the upper portion of the conveyance machine 103. The conveyance machine 103 is provided with a cylinder 106 configured to tilt the scrap S collection bin 105 rearwards, so that the collected scrap S is discharged to the rear side.

The scrap S collection bin 105 that has been lowered by the cylinder 104 receives the scrap S discharged through the discharge port 3 of the eighth discharge chute 28 and reaches a certain volume or a certain weight. Then, in a state in which the discharge port 3 of the eighth discharge chute 28 is moved upwards, the conveyance machine 103 is moved upwards along the inclined rails 102 by the cylinder 104. Thereafter, the scrap S collection bin 105 is tilted rearwards by the cylinder 106 installed on the conveyance machine 103 to discharge the collected scrap S. After that, the scrap S collection bin 105 is moved downwards again to receive the next scrap S and discharges the collected scrap S through the above-described process.

The scrap discharge hopper 100 may be configured as a two-stage scrap discharge hopper 100a or a three-stage hopper, as shown in FIG. 26, to discharge the collected scrap S to a destination.

FIG. 26 shows a state in which the scrap collection bin 105 of the scrap discharge hopper 100 is moved upwards and then is tilted to the rear side in the downward direction to empty the scrap S into the scrap collection bin 105 of the scrap discharge hopper 100a that has been moved downwards.

In the present invention, the foremost end of one side where the first discharge chute 21 is located is the highest, and the other side where the discharge port 3 is located has a low slope. Accordingly, since the scrap S dropped and introduced into the discharge chute is discharged smoothly by wave motion, it is possible to prevent deterioration in press productivity due to scrap discharge load.

The cross-sectional shape of the bottom portion 8 of the discharge chute 2 of the present invention is a semi-circular, semi-elliptical, semi-parabolic, or semi-elliptical parabolic shape. Accordingly, even if the front surface or the front and back surfaces of the scrap S are contaminated with oil such as drawing oil, it is possible to prevent contact or adhesion between the scrap S and the bottom portion 8. Accordingly, movement and discharge of the scrap S is not affected by oil.

In the present invention, since the ball plungers 30 are installed at a portion of the discharge chute 2 where the end of the neighboring discharge chute 2 is placed, the discharge chutes 2 adjacent to each other are in point contact with each other, thereby preventing surface contact or friction between the discharge chutes 2 adjacent to each other. In this manner, it is possible not only to significantly reduce shortening of the lifespan of the discharge chute 2 and noise generation, but also to perform smooth wave motion.

In the present invention, the finishing plate or the end plate 21a is fixed to the front end of the foremost first discharge chute 21, thereby preventing the scrap S introduced into the foremost first discharge chute 21 from moving in a direction opposite to the discharge port 3. Furthermore, the step portion 11 corresponding to a thickness of a plate constituting a piece chute is formed between the piece chutes and between the discharge chutes 2, so that the introduced scrap S is automatically prevented from moving or flowing back in the direction opposite to the discharge port 3.

The present invention described above is not limited to the present embodiments and the accompanying drawings, and it is obvious to those skilled in the art to which the present invention pertains that various substitutions, modifications, and variations are possible, without departing from the scope and spirit of the invention as disclosed in the accompanying claims.

1. An automatic scrap discharge system comprising:
a plurality of discharge chutes each having a bottom portion;
vertical portions respectively disposed on a front surface and a rear surface of the bottom portion, each of the vertical portions being bent upwards at a predetermined height;
reinforcing members fixed to outer surfaces of the respective vertical portions, each of the reinforcing members having an outward shaft pin formed thereon;
an upper end portion of a support member having a “U” shape, the upper end portion being axially installed on the outward shaft pin using a bearing; and
a rod of an upward-and-downward movement cylinder, the rod being vertically installed at a central lower portion of the support member,
wherein the discharge chutes are connected in a row in a state in which end portions of the adjacent discharge chutes overlap each other to provide mutual support between the end portions, and wherein the discharge chutes are configured to be moved upwards and downwards by the respective upward-and-downward movement cylinders, thereby performing overall wave motion.

2. The automatic scrap discharge system according to claim 1, wherein the bottom portion has any one of a semi-circular shape, a semi-elliptical shape, a semi-parabolic shape, and a semi-elliptical parabolic shape.

3. The automatic scrap discharge system according to claim 1, wherein a plurality of ball plungers is installed with a predetermined interval therebetween at the end portions of the discharge chutes such that the end portions of the adjacent discharge chutes are placed on the ball plungers and are supported by the ball plungers in a point-contact manner.

4. The automatic scrap discharge system according to claim 3, wherein each of the ball plungers comprises a main body having a threaded portion of a predetermined pitch, the threaded portion being formed on an outer circumferential surface of the main body, and an upwardly open spring chamber formed in the main body,
wherein a spring is inserted into and installed in the spring chamber, and
wherein a ball bearing elastically supported upwards by the spring partially protrudes outside the main body to perform rolling motion on an upper portion of the spring.

5. The automatic scrap discharge system according to claim 1, wherein the discharge chutes have step portions formed by overlapping and connecting two to eight piece chutes each having the bottom portion and the opposite vertical portions.

6. The automatic scrap discharge system according to claim 1, wherein the discharge chutes are arranged to form an inclination in such a manner that the foremost discharge chute is positioned higher than the rearmost discharge chute.

7. The automatic scrap discharge system according to claim 6, wherein the inclination ranges from 10° to 40°.

8. The automatic scrap discharge system according to claim 1, wherein the outward shaft pin is positioned closer to one side of the discharge chutes to allow the discharge chutes to be inclined.

9. The automatic scrap discharge system according to claim 1, further comprising upward protrusions bent outwards at an angle of 10° to 45° from upper portions of the respective vertical portions.

10. The automatic scrap discharge system according to claim 1, further comprising an end plate fixed to a front end of the foremost discharge chute.

11. The automatic scrap discharge system according to claim 1, wherein the discharge chutes are installed in a linear shape or are installed in a curved shape to avoid an obstacle.

12. The automatic scrap discharge system according to claim 1, further comprising a scrap discharge hopper installed at the discharge port, the scrap discharge hopper being configured to receive scrap discharged by the discharge chutes and discharge the scrap outside a space in which a press machine is installed.
